(19) United States
(12) Patent Application Publication
(10) Pub. No.: US 2004/0239849 A1
(43) Pub. Date: Dec. 2, 2004

(54) Liquid crystal display with mirror face function

(76) Inventor: Po Hsien Wang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/449,005

(22) Filed: Jun. 2, 2003

(51) Int. Cl. G02F 1/1335

(52) U.S. Cl. 349/115

(57) ABSTRACT

A liquid crystal display with mirror face function. A light deflecting plate is disposed on one face of the liquid crystal display module opposite to the backlight element. A brightness enhancement film is disposed between the liquid crystal display module and the light deflecting plate. The direction of the light penetration axis of the brightness enhancement film is identical to the direction of the light penetration axis of the liquid crystal display module, whereby external light is reflected by the brightness enhancement film to achieve a mirror face effect. The light emitted by the liquid crystal display module can easily pass through the brightness enhancement film so that the light penetrability of the liquid crystal display module is enhanced.

### BACKGROUND OF THE INVENTION

The present invention is related to a liquid crystal display with mirror face function, and more particularly to a liquid crystal display with better optical efficiency and thinner thickness. In addition, the liquid crystal display is manufactured at lower cost.

Some liquid crystal displays need to have mirror face function due to special requirement. FIG. 4 shows an in-car rearview mirror capable of showing information. A semitransparent reflecting film 82 is disposed on one face of the lens 81 of the rearview mirror. A light emitting display 83 is disposed on rear side of the lens 81. In normal state, the lens 81 can reflect external light to serve as a mirror. When the display 83 emits light, the light partially penetrates through the semitransparent reflecting film 82 to achieve display effect.

The conventional liquid crystal light-emitting display 83 includes a liquid crystal display module 831 and a backlight module 832. When the display 83 emits light, the backlight module 832 serves as the light source. Due to the working characteristic of the liquid crystal display module 831, only about one half of the emitted light can pass through the liquid crystal display module 831. The semitransparent reflecting film 82 will absorb a part of the light beam. Therefore, only about one half of the light beam passing through the liquid crystal display module 831 can pass through the semi transparent reflecting film 82. In other words, only about 25% of the light emitted by the backlight module 832 can pass through the semi transparent reflecting film 82 as shown in FIG. 5. Therefore, the aforesaid in-car rearview mirror capable of showing information has poor optical efficiency. As a result, a high brightness backlight module 832 is necessary for enhancing the brightness. This greatly increases power consumption. In the case that such display is applied to a portable implement such as a mobile phone, PDA and notebook-type computer, the great power consumption will shorten the using time. Moreover, the high brightness backlight module 832 will lead to the problem of overheating.

Another type of liquid crystal display is additionally equipped with a switch-type display (such as TN-LCD ). The turning on/off of the switch-type display is controlled by means of a circuit. When the switch-type display works, the external light is reflected to achieve a mirror face effect. When the switch-type display is turned off, the light emitted by the internal liquid crystal display module can pass through the switch-type display to serve as a display panel. Such display is thicker and has complicated structure. In addition, such display is manufactured at higher cost. Therefore, such display fails to meet the requirements for lightweight, thinness and low power consumption.

Therefore, it is necessary to provide a liquid crystal display which meets the requirements for lightweight, thinness and low power consumption and is applicable to portable implement.

### SUMMARY OF THE INVENTION

It is therefore a primary object of the present invention to provide a liquid crystal display with mirror face function. The direction of the light penetration axis of the brightness enhancement film is identical to the direction of the light penetration axis of the liquid crystal display module, whereby the light emitted by the liquid crystal display module can easily pass through the brightness enhancement film. The light beam of the external light in the direction normal to the penetration axis of the brightness enhancement film is reflected to achieve a mirror face effect. Therefore, the light penetrability of the liquid crystal display module is enhanced. In addition,while achieving mirror face function and enhancing the optical efficiency, the liquid crystal display meets the requirements for lightweight, thinness and low power consumption.

According to the above object, the liquid crystal display with mirror face function of the present invention includes a liquid crystal display module. A backlight element is disposed on one face of the liquid crystal display module to serve as a light source thereof. A light deflecting plate is disposed on the other face of the liquid crystal display module opposite to the backlight element. A dual brightness enhancement film (DBEF) is disposed between the liquid crystal display module and the light deflecting plate. The direction of the light penetration axis of the brightness enhancement film is identical to the direction of the light penetration axis of the liquid crystal display module, whereby external light is reflected by the brightness enhancement film to achieve a mirror face effect and the light emitted by the liquid crystal display module can easily pass through the brightness enhancement film.

The present invention can be best understood through the following description and accompanying drawings wherein:

### BRIEF DESCRIPTION OF THE DRAWINGS

FIG. 1 is a view showing the structure of the present invention;

FIG. 2 shows that the present invention achieves a mirror face effect under external light;

FIG. 3 shows that when the present invention works, the light emitted by the liquid crystal display module passes through the brightness enhancement film;

FIG. 4 is a view showing the structure of a conventional in-car rearview mirror capable of showing information; and

FIG. 5 shows the using state of the conventional in-car rearview mirror capable of showing information.

### DETAILED DESCRIPTION OF THE PREFERRED EMBODIMENT

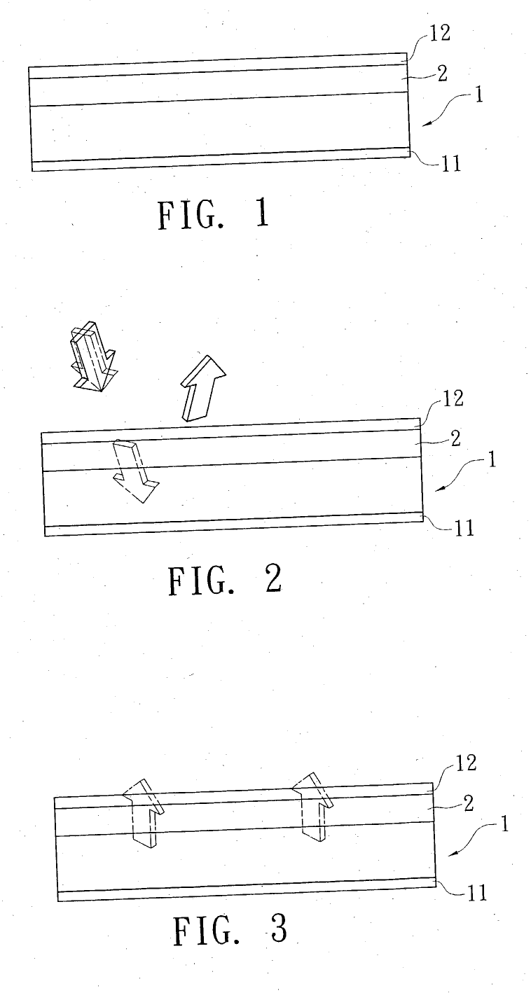

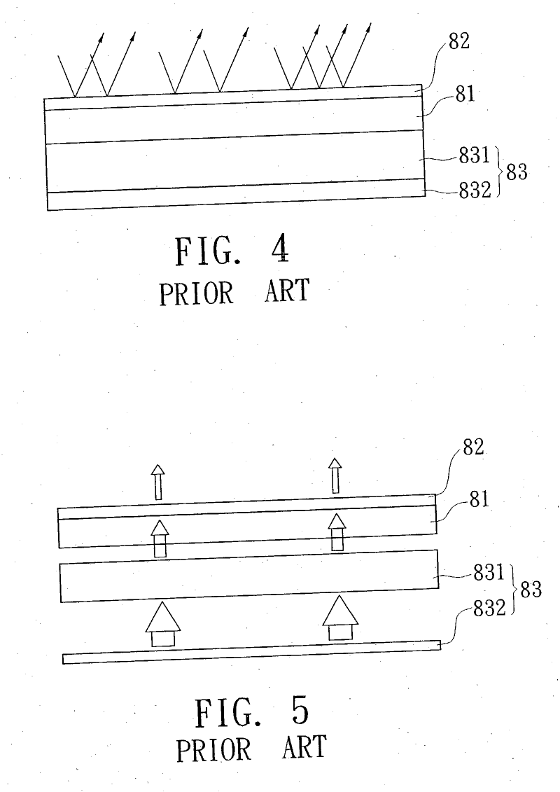

Please refer to FIGS. 1 to 3. The liquid crystal display with mirror face function of the present invention includes a liquid crystal display module 1 and a dual brightness enhancement film (DBEF) 2. A backlight element 11 is disposed on one face of the liquid crystal display module 1 to serve as the light source thereof. A light deflecting plate 12 is disposed on the other face of the liquid crystal display module 1 opposite to the backlight element 11. The DBEF 2 is disposed between the liquid crystal display module 1 and the light deflecting plate 12. The direction of the light penetration axis of the DBEF 2 is identical to the direction of the light penetration axis of the liquid crystal display module 1. Therefore, the light emitted from the liquid crystal display module 1 can easily pass through the DBEF 2.

The DBEF 2 is a product of 3M (An American company ). The DBEF 2 has special prism structure. The light beam (P light) in the direction of the penetration axis of the prism structure is permitted to pass through the DBEF 2, while the light beam (S light) in the direction normal to the penetration axis is reflected. This is a characteristic of the DBEF 2. The DBEF 2 is applied to the present invention to achieve the necessary mirror face effect by means of the above characteristic.

Referring to FIG. 2, when the liquid crystal display module 1 does not work, the backlight element 11 will not emit light. At this time, when external light is projected onto the DBEF 2, the light beam (S light) of the external light in the direction normal to the penetration axis of the DBEF 2 is reflected to present a mirror state. When the liquid crystal display module 1 works, the light emitted by the backlight element 11 will pass through the liquid crystal display module 1. The direction of the light penetration axis of the DBEF 2 is identical to the direction of the light penetration axis of the liquid crystal display module 1. Therefore, the light (P light) passing through the liquid crystal display module 1 can easily pass through the DBEF 2 as shown in FIG. 3. Accordingly, the penetrability of the light is enhanced.

In actual test of the liquid crystal display with mirror face function of the present invention, with ordinary arrangement, when the liquid crystal display module 1 works, the brightness is up to 120 cd/m². Therefore, a good display effect can be achieved without using the high brightness backlight module with higher power as in the prior art.

In conclusion, the direction of the light penetration axis of the DBEF 2 is identical to the direction of the light penetration axis of the liquid crystal display module 1. Therefore, the light emitted by the liquid crystal display module 1 can easily pass through the DBEF 2. The light beam of the external light in the direction normal to the penetration axis of the DBEF 2 is reflected by the DBEF 2 to achieve a mirror face effect. Therefore, the light penetrability of the liquid crystal display module 1 is enhanced.

The above embodiment is only used to illustrate the present invention, not intended to limit the scope thereof. Many modifications of the above embodiment can be made without departing from the spirit of the present invention.

What is claimed is:

1. A liquid crystal display with mirror face function, comprising a liquid crystal display module and a brightness enhancement film, a backlight element being disposed on one face of the liquid crystal display module to serve as a light source thereof, a light deflecting plate being disposed on the other face of the liquid crystal display module opposite to the backlight element, the brightness enhancement film being disposed between the liquid crystal display module and the light deflecting plate, the direction of the light penetration axis of the brightness enhancement film being identical to the direction of the light penetration axis of the liquid crystal display module, whereby external light is reflected by the brightness enhancement film to achieve a mirror face effect and the light emitted by the liquid crystal display module can easily pass through the brightness enhancement film.

2. The liquid crystal display with mirror face function as claimed in claim 1, wherein the brightness enhancement film is a DBEF.
